(19) United States
(12) Patent Application Publication
(10) Pub. No.: US 2025/0173156 A1
(43) Pub. Date: May 29, 2025

(54) BOOT CONTROL METHOD AND ELECTRONIC DEVICE

(71) Applicant: ASUS GLOBAL PTE. LTD., Singapore (SG)

(72) Inventors: Zhong Gang Cheng, Singapore (SG); Sheng Qin, Singapore (SG); Ming Jiang Hou, Singapore (SG)

(73) Assignee: ASUS GLOBAL PTE. LTD., Singapore (SG)

(21) Appl. No.: 18/939,553

(22) Filed: Nov. 7, 2024

(30) Foreign Application Priority Data
Nov. 29, 2023 (CN) 202311620036.5

(51) Int. Cl. G06F 9/4401

(52) U.S. Cl. CPC G06F 9/4408

(57) ABSTRACT

A boot control method and an electronic device are disclosed. The method includes: activating a boot procedure of the electronic device; during an execution of the boot procedure, receiving a wireless verification signal through a wireless communication circuit of the electronic device, in which the wireless verification signal carries verification information; determining whether the verification information passes verification; in response to the verification information passing the verification, continuing executing the boot procedure; and in response to the verification information not passing the verification, stopping the boot procedure. In this way, the user experience can be effectively enhanced while at the same time taking into account the security protection for the boot of the electronic device.

### CROSS-REFERENCE TO RELATED APPLICATION

This application claims the priority benefit of China application serial no. 202311620036.5, filed on Nov. 29, 2023. The entirety of the above-mentioned patent application is hereby incorporated by reference herein and made a part of this specification.

### BACKGROUND

### Technical Field

This disclosure relates to a boot control technology, in particular to a boot control method and an electronic device.

### Description of Related Art

In general, to enhance the information security of electronic devices such as smartphones or laptop computers, some types of electronic devices support verification of the identity of the electronic device at the time of booting up in the form of manual input of account/password, graphical verification, or biometric verification (e.g., face verification or fingerprint verification). Only after the identity verification is passed, the boot procedure of the electronic device can continue. However, under certain circumstances (e.g., when there is a small distance between the user and the electronic device), the boot procedure of the electronic device cannot continue, which in turn may cause a nuisance to the user.

### SUMMARY

The embodiment of the disclosure provides a boot control method adapted to an electronic device. The electronic device has a wireless communication circuit. The boot control method includes the following. A boot procedure of the electronic device is activated. During an execution of the boot procedure, a wireless verification signal is received through a wireless communication circuit, in which the wireless verification signal carries verification information. Whether the verification information passes verification is determined. In response to the verification information passing the verification, the boot procedure is continued executing. In response to the verification information not passing the verification, the boot procedure is stopped.

The embodiment of the disclosure further provides an electronic device including a wireless communication circuit and a processor. The processor is connected to the wireless communication circuit. The processor is configured to: activate a boot procedure of the electronic device; during an execution of the boot procedure, receive a wireless verification signal through a wireless communication circuit, in which the wireless verification signal carries verification information; determine whether the verification information passes verification; in response to the verification information passing the verification, continue executing the boot procedure; and in response to the verification information not passing the verification, stop the boot procedure.

Based on the above, the boot control method and the electronic device provided by the implementation of the disclosure may be verified through the wireless verification signal received when the electronic device executes the boot procedure. If the verification is passed, the boot procedure may continue to be executed. However, if verification fails, the boot procedure may stop automatically. In this way, the user experience may be effectively enhanced while at the same time taking into account the security protection for the boot of the electronic device.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate example embodiments of the disclosure and, together with the description, serve to explain the principles of the disclosure.

FIG. 1 is a schematic diagram of a boot verification system according to an embodiment of the disclosure.

FIG. 2 is a schematic diagram illustrating the relative relationship in time between a boot procedure and at least one verification point according to an embodiment of the disclosure.

FIG. 3 is a flow chart of a boot control method according to an embodiment of the disclosure.

### DESCRIPTION OF THE EMBODIMENTS

Reference will now be made in detail to the exemplary embodiments of the disclosure, examples of which are illustrated in the accompanying drawings. Whenever possible, the same reference numbers are used in the drawings and descriptions to refer to the same or similar parts.

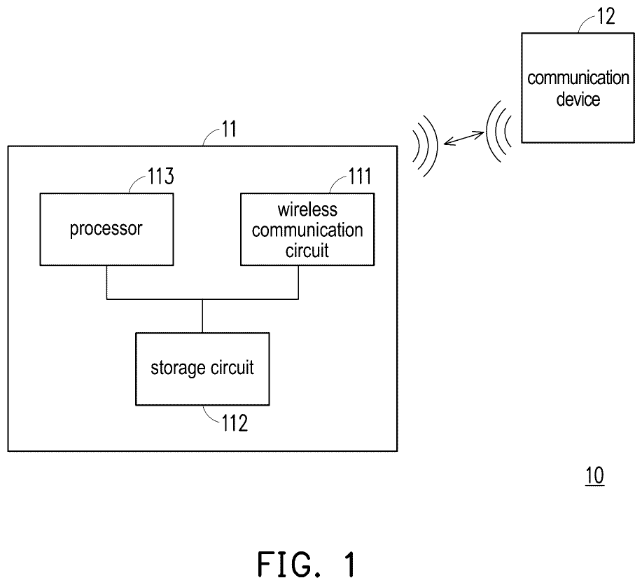

Referring to FIG. 1, a boot verification system 10 includes an electronic device 11 and a communication device 12. The electronic device 11 can be an electronic device that supports wireless communication functions such as a smartphone, a tablet computer, a laptop computer, a desktop computer, a smart watch, a wireless speaker, a game console, a smart TV, an industrial computer, a vehicle-mounted computer or server, and the type of the electronic device 11 is not limited thereto. In addition, the communication device 12 can be a portable electronic device that supports wireless communication functions such as a smartphone, a tablet computer, a laptop computer, or a smart watch, and the type of the communication device 12 is not limited thereto. Wireless communication can be performed between the electronic device 11 and the communication device 12.

The electronic device 11 includes a wireless communication circuit 111, a storage circuit 112, and a processor 113. The wireless communication circuit 111 is used to provide the wireless communication function of the electronic device 11. For example, the wireless communication circuit 111 may be used to wirelessly communicate with the communication device 12. For example, the electronic device 11 may receive a wireless signal from the communication device 12 or send a wireless signal to the communication device 12 through the wireless communication circuit 111. For example, the wireless communication circuit 111 may support wireless communication standards such as Bluetooth, Near-Field Communication (NFC), or Wi-Fi, and the wireless communication standards that the wireless communication circuit 111 can support are not limited thereto.

The storage circuit 112 is used to store data. For example, the storage circuit 112 may include a read only memory (ROM), a solid-state disk (SSD), a hard disk drive (HDD), a flash memory module, or an embedded multimedia card (eMMC), a Universal Flash Storage (UFS) device, or similar non-volatile storage media.

The processor 113 is connected to the wireless communication circuit 111 and the storage circuit 112. The processor 113 may be responsible for all or part of the operation of the electronic device 11. For example, the processor 113 may include a central processing unit (CPU) or other programmable general-purpose or special-purpose microprocessor, digital signal processor (DSP), programmable controller, application specific integrated circuits (ASIC), programmable logic device (PLD) or other similar devices or a combination of these devices. In an embodiment, the processor 113 can activate a boot procedure of the electronic

device 11. For example, in response to a boot signal, the processor 113 can activate the boot procedure of the electronic device 11. For example, the boot signal may be generated by a user triggering (for example, pressing or touching) a boot button of the electronic device 11. After activating the boot procedure of the electronic device 11, the processor 113 can read a boot code of the electronic device 11 from the storage circuit 112. Then, the processor 113 can run the boot code to perform the boot procedure. For example, the boot procedure is used to boot the electronic device 11. After the electronic device 11 is booted, the processor 113 can run a preset operating system (OS) for the user to operate the electronic device 11.

In an embodiment, during an execution of the boot procedure, the processor 113 may receive a wireless signal (also called a wireless verification signal) from the communication device 12 through the wireless communication circuit 111. The wireless verification signal may carry verification information. For example, during the execution of the boot procedure, the processor 113 may first activate the wireless communication circuit 111 and perform initialization of the wireless communication circuit 111. After activating the wireless communication circuit 111 and completing the initialization of the wireless communication circuit 111, the processor 113 can receive the wireless verification signal through the wireless communication circuit 111.

In an embodiment, the processor 113 can parse the verification information from the wireless verification signal. Then, the processor 113 can determine whether the verification information passes verification. In response to the verification information passing the verification, the processor 113 can continue to execute the boot procedure. However, if the verification information does not pass the verification, the processor 113 may stop the boot procedure (i.e., interrupt the boot procedure) before completing the boot procedure. In addition, in an embodiment, during the execution of the boot procedure, if the wireless communication circuit 111 does not receive any wireless verification signal with the verification information, the processor 113 may also stop the boot procedure before completing the boot procedure.

In an embodiment, during the execution of the boot procedure, the processor 113 can continuously detect whether a verification point (also called a checkpoint) of the boot procedure has been reached. In response to having reached the verification point in the boot procedure, the processor 113 may perform an operation of determining whether the verification information passes the verification. However, if the verification point has not been reached, the processor 113 may continue executing the boot procedure.

In an embodiment, the boot procedure includes a boot procedure of a Universal Extensible Firmware Interface (UEFI), but the disclosure is not limited thereto. In an embodiment, the boot procedure may also include other types of boot procedures, such as a traditional basic input/output system (BIOS) boot procedure, which the disclosure is not limited to.

In an embodiment, taking the UEFI boot procedure as an example, the verification point may correspond to at least one of a Pre-EFI initialization (PEI) phase in the boot procedure, a Driver Execution Environment (DXE) phase in the boot procedure, and the Boot Device Selection (BDS) phase in the boot procedure. For example, during the execution of the UEFI boot procedure, when entering, executing, or ending the PEI phase, DXE phase, or BDS phase, the processor 113 may determine that the verification point has been reached. In an embodiment, the total number and configuration of the verification point can be adjusted according to practical needs, and the disclosure is not limited thereto.

Specifically, the PEI phase in the UEFI boot procedure is mainly used to initialize a chipset and storage inside the electronic device 11. The DXE phase in the UEFI boot procedure mainly completes the initialization of most of the hardware inside the electronic device 11 by running various drivers. In addition, the BDS phase in the UEFI boot procedure is used to perform the enumeration of the peripheral component interconnect (PCI) bus, the initialization of peripheral devices (such as monitors, mice, and keyboards), and the initialization of the operating system. Those skilled in the art may be aware of the specific definitions of each phase in the UEFI boot procedure, and therefore will not be repeated in the following. Additionally, for other types of boot procedures, the verification point may be configured according to one or more phases in the boot procedure, and the disclosure is not limited thereto.

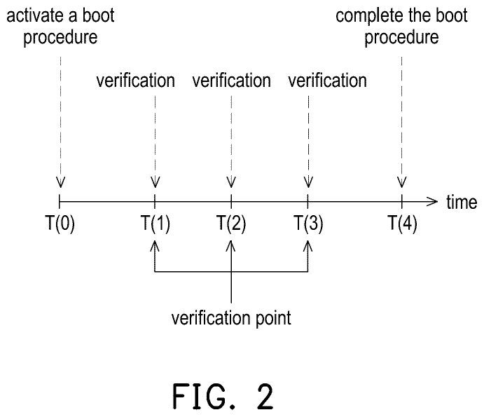

Please refer to FIG. 2. In an embodiment, it is assumed that at time point T(0), the processor 113 activates the UEFI boot procedure. In addition, it is assumed that time points T(1), T(2), and T(3) respectively correspond to time points when the PEI phase, DXE phase, or BDS phase is entered, executed, or ended in the UEFI boot procedure.

In an embodiment, after activating the boot procedure, at at least one of time points T(1), T(2), and T(3), the processor 113 may determine that the verification point has been reached and perform an operation of determining whether or not the verification information passes the verification. If the verification information passes the verification, the processor 113 can continue to execute the boot procedure. However, if the verification information does not pass the verification, the processor 113 can directly stop the boot procedure. In addition, if one or more verifications scheduled to be executed have passed, then at time point T(4), the processor 113 completes the boot procedure.

In an embodiment, the processor 113 may only perform the operation of determining whether the verification information passes the verification at one of the time points T(1), T(2), and T(3). Alternatively, in an embodiment, the processor 113 may also perform the operation of determining whether the verification information passes the verification at at least two of the time points T(1), T(2), and T(3).

In an embodiment, during the operation of determining whether the verification information passes the verification, the processor 113 may decrypt (including decode) the verification information obtained from the wireless verification signal to obtain a verification code. The processor 113 can determine whether the verification code complies with specifications. For example, after obtaining the verification code, the processor 113 can input the verification code into a preset algorithm or operation model and determine whether the verification code complies with the specifications based on the output of the algorithm or operation model. In response to the verification code complying with the specifications, the processor 113 may determine that the verification information passes the verification. However, if the verification code does not comply with the specifications, the processor 113 may determine that the verification information does not pass the verification.

In an embodiment, during the execution of the boot procedure, after determining that the verification information does not pass the verification, the processor 113 may perform at least one retry. For example, in the at least one retry, the processor 113 may try to receive the wireless verification signal from the communication device 12 again through the wireless communication circuit 111 and/or re-determine the verification information parsed from the wireless verification signal passes the verification. If in the at least one retry, the processor 113 instead determines that the verification information passes the verification, the processor 113 may continue to execute the boot procedure. However, if the processor 113 still determines that the verification information does not pass the verification in the at least one retry, the processor 113 may stop the boot procedure before completing the boot procedure.

In an embodiment, during the execution of the boot procedure (for example, at the verification point), the processor 113 may also determine whether a signal strength of the wireless verification signal is higher than a critical value. For example, the signal strength of the wireless verification signal may be positively related to a distance between the electronic device 11 and the communication device 12. That is, if the distance between the electronic device 11 and the communication device 12 is closer, the signal strength of the wireless verification signal may be higher.

In an embodiment, in response to the signal strength of the wireless verification signal being higher than the critical value, the processor 113 may continue to perform an operation of determining whether the verification information passes the verification and decide whether to stop or continue to execute the boot procedure according to a determining result. However, if the signal strength of the wireless verification signal is not higher than the critical value, the processor 113 can directly stop the boot procedure.

In an embodiment, if the boot procedure is stopped in response to the signal strength of the wireless verification signal not being higher than the critical value, then after the signal strength of the wireless verification signal is increased to higher than the critical value, the processor 113 may resume execution of the boot procedure (or execution of the operation of determining whether the verification information passes the verification). Accordingly, when the user notices that the boot procedure stops unexpectedly due to the distance between the communication device 12 and the electronic device 11 being too far, the user can move the communication device 12 closer to the electronic device 11 to trigger the electronic device 11 to continue executing the boot procedure.

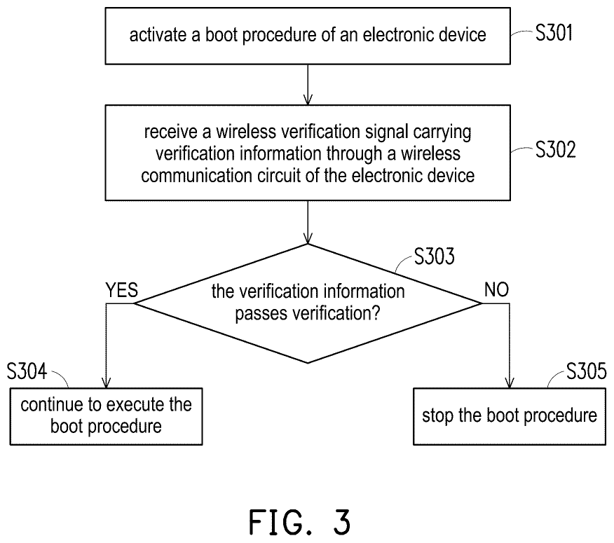

Referring to FIG. 3, In step S301, the boot procedure of the electronic device is activated. In step S302, during the execution of the boot procedure, a wireless verification signal is received through the wireless communication circuit of the electronic device, where the wireless verification signal carries verification information. In step S303, whether the verification information passes verification is determined. In response to the verification information passing the verification, in step S304, the boot procedure continues to be executed. On the other hand, if the verification information does not pass the verification, in step S305, the boot procedure is stopped.

Each step in FIG. 3 has been described in detail above and therefore will not be repeated in the following. It should be noted that each step in FIG. 3 can be implemented as multiple program codes or circuits, and the disclosure is not limited thereto. In addition, the method in

FIG. 3 can be used in conjunction with the above exemplary embodiments or can be used alone, and the disclosure is not limited thereto.

In summary, the boot control method and the electronic device provided by the implementation of the disclosure may be verified through the wireless verification signal received when the electronic device executes the boot procedure. If the verification is passed, the boot procedure may continue to be executed. However, if verification fails, the boot procedure may stop automatically. In this way, the user experience may be effectively enhanced while at the same time taking into account the security protection for the boot of the electronic device.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A boot control method, adapted to an electronic device, wherein the electronic device has a wireless communication circuit, and the boot control method comprises:
activating a boot procedure of the electronic device;
during an execution of the boot procedure, receiving a wireless verification signal through a wireless communication circuit, wherein the wireless verification signal carries verification information;
determining whether the verification information passes verification;
in response to the verification information passing the verification, continuing executing the boot procedure; and
in response to the verification information not passing the verification, stopping the boot procedure.

2. The boot control method according to claim 1, wherein determining whether the verification information passes the verification comprises:
detecting whether a verification point of the boot procedure has been reached;
in response to having reached the verification point, determining whether the verification information passes the verification; and
in response to not having reached the verification point, continuing executing the boot procedure.

3. The boot control method according to claim 2, wherein the boot procedure comprises a boot procedure of a Universal Extensible Firmware Interface (UEFI).

4. The boot control method according to claim 3, wherein the verification point corresponds to at least one of a Pre-EFI initialization (PEI) phase in the boot procedure, a Driver Execution Environment (DXE) phase in the boot procedure, and the Boot Device Selection (BDS) phase in the boot procedure.

5. The boot control method according to claim 1, wherein determining whether the verification information passes the verification comprises:
decrypting the verification information to obtain a verification code;
determining whether the verification code complies with specifications;
in response to the verification code complying with the specifications, determining that the verification information passes the verification; and
in response to the verification code not complying with the specifications, determining that the verification information does not pass the verification.

6. The boot control method according to claim 1, wherein determining whether the verification information passes the verification comprises:
determining whether a signal strength of the wireless verification signal is higher than a critical value; and
in response to the signal strength of the wireless verification signal not being higher than the critical value, determining that the verification information does not pass the verification.

7. An electronic device, comprising:
a wireless communication circuit; and
a processor, connected to the wireless communication circuit, wherein the processor is configured to:
activate a boot procedure of the electronic device;
during an execution of the boot procedure, receive a wireless verification signal through a wireless communication circuit, wherein the wireless verification signal carries verification information;
determine whether the verification information passes verification;
in response to the verification information passing the verification, continue executing the boot procedure; and
in response to the verification information not passing the verification, stop the boot procedure.

8. The electronic device according to claim 7, wherein an operation of the processor determining whether the verification information passes the verification comprises:
detecting whether a verification point of the boot procedure has been reached;
in response to having reached the verification point, determining whether the verification information passes the verification; and
in response to not having reached the verification point, continuing executing the boot procedure.

9. The electronic device according to claim 8, wherein the boot procedure comprises a boot procedure of a Universal Extensible Firmware Interface.

10. The electronic device according to claim 9, wherein the verification point corresponds to at least one of a Pre-EFI initialization (PEI) phase in the boot procedure, a Driver Execution Environment (DXE) phase in the boot procedure, and the Boot Device Selection (BDS) phase in the boot procedure.

11. The electronic device according to claim 7, wherein an operation of the processor determining whether the verification information passes the verification comprises:
decrypting the verification information to obtain a verification code;
determining whether the verification code complies with specifications;
in response to the verification code complying with the specifications, determining that the verification information passes the verification; and
in response to the verification code not complying with the specifications, determining that the verification information does not pass the verification.

12. The electronic device according to claim 7, wherein an operation of the processor determining whether the verification information passes the verification comprises:
determining whether a signal strength of the wireless verification signal is higher than a critical value; and
in response to the signal strength of the wireless verification signal not being higher than the critical value, determining that the verification information does not pass the verification.
